(19) United States
(12) Patent Application Publication
(10) Pub. No.: US 2024/0053426 A1
(43) Pub. Date: Feb. 15, 2024

(54) Orientation Determination of a Wireless Device

(71) Applicant: Telefonaktiebolaget LM Ericsson (publ), Stockholm (SE)

(72) Inventors: Tore Lindgren, Luleå (SE); Sara Sandberg, Luleå (SE)

(21) Appl. No.: 18/271,204

(22) PCT Filed: Mar. 8, 2021
(86) PCT No.: PCT/SE2021/050202

§ 371 Date: Jul. 6, 2023

(51) Int. Cl. G01S 3/14; G01S 3/72

(52) U.S. Cl. CPC G01S 3/143; G01S 3/72

(57) ABSTRACT

There is provided mechanisms for orientation determination of a wireless device with respect to a first coordinate system. A method is performed by a control unit. The method comprises obtaining first angular measurements of the wireless device at a first access node and second angular measurements of the first access node at the wireless device. The first access node is oriented in the first coordinate system. The wireless device is oriented in a second coordinate system. The method comprises determining, by aligning the second angular measurements with the first angular measurements, an amount of rotation of the second coordinate system with respect to the first coordinate system. The orientation of the wireless device with respect to the first coordinate system is defined by the amount of the rotation.

### TECHNICAL FIELD

Embodiments presented herein relate to a method, a control unit, a computer program, and a computer program product for orientation determination of a wireless device with respect to a first coordinate system.

### BACKGROUND

In some use-cases and scenarios it could be useful to determine the orientation (sometimes referred to as the attitude) of a device. For example, a common means of estimating the orientation of a device in term of a vehicle is to use an Attitude and Heading Reference System (AHRS). Such a system includes an inertial measurement unit (IMU) that comprises gyroscopes and accelerometers, and magnetometers on three axes. The gyroscopes can measure the rotation of the vehicle with high short-time accuracy but will drift over time. This is compensated for with measurements of the gravity vector (provided by the accelerometers) and the magnetic field vector (provided by the magnetometers).

A Global Navigation Satellite System (GNSS) receiver might be added in order to provide a position measurement. The orientation and position of a vehicle (or any other type of device) can also be estimated using coupled GNSS and IMU in a similar way as in AHRS, where the GNSS receiver is used to calibrate the IMU measurements.

By using a GNSS receiver with multiple antennas, the orientation of the device can be estimated using the same type of techniques as is used in carrier phase differential techniques, such as Real-Time Kinematic (RTK). One difference is that since the distance between the antennas is assumed to be known, the relative position of the different antennas can be used to calculate the orientation of the device. This technique provides a direct measurement of the orientation since the direction of the vector pointing from the GNSS receiver towards the satellites is known with high accuracy (due to the small position errors compared to the distance to the satellites). As an example, the direction, in the global coordinate system, from a wireless device equipped with a GNSS receiver towards a (radio) access node can then be calculated using the estimated positions of the wireless device and the (radio) access node.

Depending on the distance between the antennas in the wireless device, the differential techniques used in GNSS based orientation estimation can be used or the angle-of-arrival (AoA) on the wireless device side can be estimated directly.

The AoA can be obtained by exploiting the fact that the phase difference of the received signal between two antennas in an antenna array is equal to the dot product of the vectors describing the relative position of the antennas and the unit vector pointing from the receiver towards the transmitter. Reference is here made to FIG. 1 which schematically illustrates a wireless device 400 having four antennas 410a:410d. The wireless device is oriented with respect to a coordinate system defined by unit vectors x, y, z. A signal is received from an imagined transmitter (such as from an access node) located in the direction given by the vector \hat{r}. With reference to FIG. 1, the phase ψₙ of the signal at antenna n is given by:

ψₙ=krₙ·\hat{r} (1)

where

$$k = \frac{2 π}{λ} ,$$

where λ is the wavelength, where rₙ is the position of antenna n, and where \hat{r} is a unit vector pointing from the receiver towards the transmitter, which is determined using the AoA (or angle-of-departure (AoD), but then with opposite sign). It is here assumed that the AoA refers to the line-of-sight path between the access node 300a and the wireless device 400.

The AoA or AoD can also be determined in the beam domain by taking the two-dimensional Fourier transform of the amplitude and phase of the received signal at each antenna. In case of a multipath transmission and/or reception, multiple beams will be present and it is thus often possible (with additional processing) to discriminate between the line-of-sight (LoS) beams and non-LoS (NLoS) beams, assuming that a LoS beam indeed exists. The accuracy of the AoA estimate will depend primarily on the electrical size of the antenna array (i.e., the size in terms of wavelengths) and the number of antennas.

In general terms, techniques used for GNSS based orientation determination might require, in addition to AoA measurements in the GNSS receiver, estimates of the GNSS receiver position and the satellite position. The errors in the estimates of these positions must be significantly smaller than the distance between the GNSS receiver and the satellite. Further, techniques based on GNSS based orientation might suffer from performance degradation due to low signal strength values if the wireless device is located indoors. Applying the above techniques directly to a scenario with short distances between the wireless device and the (radio) access node leads to very strict requirements on the accuracy of the estimates of the positions. In some scenarios, such as when the wireless device is located indoors, these accuracy requirements are not always met, or the position of the wireless device might not be known. This results in poor knowledge, or even no knowledge at all, of the orientation of the wireless device.

With respect to AHRS, this technique typically uses magnetometers to estimate the Earth's magnetic field vector. Magnetometers might in some scenarios be affected by external perturbations (which e.g. are common in industrial environments).

With respect to using inertial measurements, in a dynamic scenario the sensors used for inertial measurements will be affected by the acceleration of the device, and this might significantly degrade the accuracy of the estimation of the orientation.

Hence, there is still a need for improved techniques for estimating the orientation of devices, and in particular wireless devices.

### SUMMARY

An object of embodiments herein is to address the above issues by providing efficient techniques for estimating the orientation of devices, and in particular wireless devices.

According to a first aspect there is presented a method for orientation determination of a wireless device with respect to a first coordinate system. The method is performed by a control unit. The method comprises obtaining first angular measurements of the wireless device at a first access node and second angular measurements of the first access node at the wireless device. The first access node is oriented in the first coordinate system. The wireless device is oriented in a second coordinate system. The method comprises determining, by aligning the second angular measurements with the first angular measurements, an amount of rotation of the second coordinate system with respect to the first coordinate system. The orientation of the wireless device with respect to the first coordinate system is defined by the amount of the rotation.

According to a second aspect there is presented a control unit for orientation determination of a wireless device with respect to a first coordinate system. The control unit comprises processing circuitry. The processing circuitry is configured to cause the control unit to obtain first angular measurements of the wireless device at a first access node and second angular measurements of the first access node at the wireless device. The first access node is oriented in the first coordinate system. The wireless device is oriented in a second coordinate system. The processing circuitry is configured to cause the control unit to determine, by aligning the second angular measurements with the first angular measurements, an amount of rotation of the second coordinate system with respect to the first coordinate system. The orientation of the wireless device with respect to the first coordinate system is defined by the amount of the rotation.

According to a third aspect there is presented a control unit for orientation determination of a wireless device with respect to a first coordinate system. The control unit comprises an obtain module configured to obtain first angular measurements of the wireless device at a first access node and second angular measurements of the first access node at the wireless device. The first access node is oriented in the first coordinate system. The wireless device is oriented in a second coordinate system. The control unit comprises a determine module configured to determine, by aligning the second angular measurements with the first angular measurements, an amount of rotation of the second coordinate system with respect to the first coordinate system. The orientation of the wireless device with respect to the first coordinate system is defined by the amount of the rotation.

According to a fourth aspect there is presented a computer program for orientation determination of a wireless device with respect to a first coordinate system, the computer program comprising computer program code which, when run on a control unit 200, causes the control unit to perform a method according to the first aspect.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects provide efficient estimation of the orientation of the wireless device.

Advantageously, these aspects do not suffer from the issues noted above.

Advantageously, these aspects enable the orientation of the wireless device to be determined without knowledge of the actual position of the wireless device and the actual position of the access node(s).

Advantageously, in cases where actual position of the wireless device and the actual position of the access node(s) are known, these aspects reduce, or even remove, any impacts of positioning errors on the orientation estimation.

Advantageously, these aspects enable the orientation of the wireless device to be determined independently of sensors such as inertial sensors and magnetometers. In turn, this makes the orientation independent of any acceleration of the wireless device and independent on any impact from environments with significant perturbations of the local magnetic field.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 schematically illustrates a wireless device oriented in a coordinate system according to embodiments;

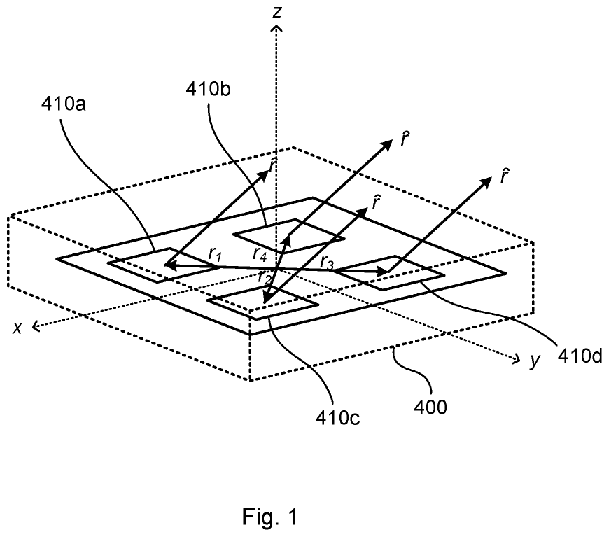

FIG. 2 and FIG. 5 are flowcharts of methods according to embodiments;

FIG. 3 and FIG. 4 schematically illustrate access node(s) oriented in a first coordinate system and a wireless device oriented in a second coordinate system according to embodiments;

FIG. 6 is a schematic diagram showing functional units of a control unit according to an embodiment;

FIG. 7 is a schematic diagram showing functional modules of a control unit according to an embodiment; and

FIG. 8 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

As noted above, there is still a need for improved techniques for estimating the orientation of devices, and in particular wireless devices.

he embodiments disclosed herein therefore relate to mechanisms for orientation determination of a wireless device 400 with respect to a first coordinate system. In order to obtain such mechanisms there is provided a control unit, a method performed by the control unit, a computer program product comprising code, for example in the form of a computer program, that when run on a control unit, causes the control unit to perform the method.

There could be different types of wireless devices 400. In some non-limiting examples, the wireless device is any of: a portable wireless device, mobile station, mobile phone, handset, wireless local loop phone, user equipment (UE), smartphone, laptop computer, tablet computer, network equipped sensor, network equipped vehicle, wearable electronic device, Internet-of-Things (IoT) device.

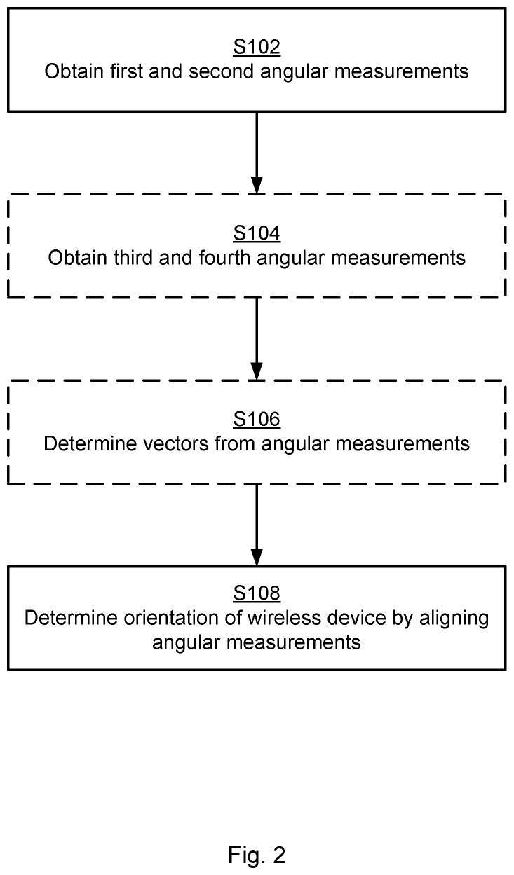

FIG. 2 is a flowchart illustrating embodiments of methods for orientation determination of a wireless device 400 with respect to a first coordinate system. The methods are performed by the control unit 200. The methods are advantageously provided as computer programs 820.

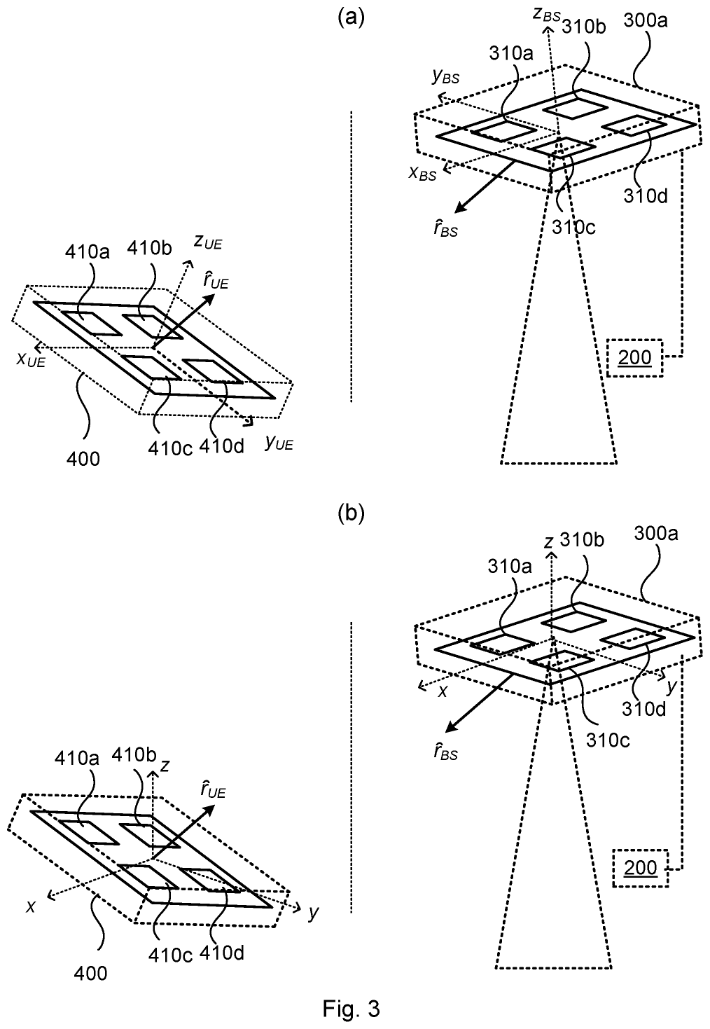

Parallel reference is made to FIG. 3 that illustrates a first access node 300a, a wireless device 400, and a control unit 200. Each of the first access node 300a and the wireless device 400 comprise four antennas 310a:310d, 410a:410d. The control unit 200 might be part of the wireless device 400, the first access node 300a, a core network node (not shown), or be a standalone device. In FIG. 3 the orientation determination of the wireless device 400 is made in the coordinate system of the first access node 300a using angular measurements at the first access node 300a and the wireless device 400.

In some aspects, in order to calculate the orientation of the wireless device 400 using radio signals it is necessary to know the direction between the wireless device 400 and the first access node 300a in both the coordinate system of the wireless device 400 and the coordinate system of the first access node 300a. The control unit 200 is therefore configured to perform step S102:

S102: The control unit 200 obtains first angular measurements of the wireless device 400 at a first access node 300a and second angular measurements of the first access node 300a at the wireless device 400. The first access node 300a is oriented in the first coordinate system. The wireless device 400 is oriented in a second coordinate system.

It could be that the second coordinate system is rotated with respect to the first coordinate system, depending on the orientation of the wireless device 400. The orientation of the wireless device 400 is therefore found by rotation of the coordinate system of the wireless device 400 (so that the vectors describing the direction between the wireless device 400 and the first access node 300a are aligned). The control unit 200 is therefore configured to perform step S108:

S108: The control unit 200 determines, by aligning the second angular measurements with the first angular measurements, an amount of rotation of the second coordinate system with respect to the first coordinate system. The orientation of the wireless device 400 with respect to the first coordinate system is then defined by the determined amount of the rotation.

In FIG. 3(a) is shown that the first access node 300a is oriented with respect to a first coordinate system defined by unit vectors x_{BS}, y_{BS}, and z_{BS}, whereas the wireless device 400 is oriented with respect to a second coordinate system defined by unit vectors x_{UE}, y_{UE}, and z_{UE}. With respect to the wireless device 400, the first access node 300a is located in the direction given by the vector \hat{r}_{UE}, and with respect to the first access node 300a, the wireless device 400 is located in the direction given by the vector \hat{r}_{BS}. In FIG. 3(b) is shown that the first access node 300a and the wireless device 400 are both oriented with respect to a common coordinate system defined by unit vectors x, y, and z, which is identical to the first coordinate system. The second coordinate system has thus been rotated so as to align the vector \hat{r}_{UE} with the vector \hat{r}_{BS} and the amount of rotation defines the orientation of the wireless device 400 with respect to the first coordinate system.

Embodiments relating to further details of orientation determination of a wireless device 400 with respect to a first coordinate system as performed by the control unit 200 will now be disclosed.

Although raw data, such as complex-valued amplitude (thus including the phase), signal strength measurements or the like, is measured at the wireless device 400 and the first access node 300a, the actual calculation of the angular measurements might be performed elsewhere, for example by the control unit 200. In particular, in some non-limiting examples, the angular measurements are determined by any of: the wireless device 400 itself, the first access node 300a itself, at least partly by the wireless device 400 and at least partly by the first access node 300a, by a core network node operatively connected to the first access node 300a, or by the control unit 200.

There could be different types of coordinate systems. As follows from above, the second coordinate system is the local coordinate system of the wireless device 400 itself and the first coordinate system is the local coordinate system of the first access node 300a itself (i.e., a coordinate system local to the first access node 300a). Further in this respect, in some embodiments, the first coordinate system is a global coordinate system. In other respects the first coordinate system has a known relation (in terms of rotation) to the global coordinate system. It could also be that each access node 300a, 300b (see. FIG. 4) has its own local coordinate system, where the local coordinate system of each access node 300a, 300b has a known relation to the global coordinate system, and/or where the local coordinate system of one of the access nodes 300a, 300b is the global coordinate system. This makes it possible to determine the orientation of the wireless device 400 in the global coordinate system. In order to simplify the notation, but without loss of generality, it will hereinafter be assumed that all access node 300a, 300b have one and the same coordinate system.

There could be different types of angular measurements. In some embodiments, the angular measurements are either AoA measurements or AoD measurements. In some examples, when the first angular measurements are AoA measurements, the first angular measurements represent the AoA of a signal received by the first access node 300a from the wireless device 400. In some examples, when the second angular measurements are AoA measurements, the second angular measurements represent the AoA of a signal received by the wireless device 400 from the first access node 300a. In some examples, when the first angular measurements are AoD measurements, the first angular measurements represent the AoD of a signal transmitted by the first access node 300a towards the wireless device 400. In some examples, when the second angular measurements are AoD measurements, the second angular measurements represent the AoD of a signal transmitted by the wireless device 400 towards the first access node 300a.

In some aspects, in order to uniquely determine the orientation of the wireless device 400, at least two measurements of different directions (corresponding to two different access nodes 300a, 300b) are needed. Hence, in some embodiments, the orientation of the wireless device 400 further is determined by supplementary orientation indicating information. This supplementary orientation indicating information could be provided either in terms of directions to at least one further (second) access node 300b or any other known direction, such as for example the magnetic field vector or the earths gravitational vector.

In particular, in some embodiments, the control unit 200 is configured to perform (optional) step S104:

S104: The control unit 200 obtains third angular measurements of the wireless device 400 at a second access node 300b and fourth angular measurements of the second access node 300b at the wireless device 400.

The second access node 300b is oriented in the first coordinate system. The orientation of the wireless device 400 is then further defined by an amount of rotation of the second coordinate system with respect to the first coordinate system needed for aligning the fourth angular measurements with the third angular measurements.

The third angular measurements and the fourth angular measurements could then define the supplementary orientation indicating information. In this respect it is noted that yet further angular measurements from yet further access nodes could be used and define the supplementary orientation indicating information.

In particular, in some embodiments, the wireless device 400 is equipped with at least one orientation indicating sensor, and the orientation of the wireless device 400 further is determined using an orientation indicating signal as provided by the orientation indicating sensor. The orientation indicating signal could then define the supplementary orientation indicating information. Non-limiting examples of the orientation indicating sensor include, but are not limited to: an accelerometer, a gravity sensor, a magnetometer.

Further details of how angular measurements from (at least) two access nodes 300a, 300b could be utilized when determining the orientation of the wireless device 400 will now be disclosed.

In general terms, two angles, for example azimuth and elevation, might be needed to describe one of the coordinate axes of any coordinate system. The other two axes are in the plane perpendicular to the first found axis, and thus one additional angle (the rotation around the first found axis) is needed to describe the second axis. The third axis completes the coordinate system. The problem of determining the orientation of the wireless device 400 (or the orientation of the second coordinate system) might thus include three unknown quantities. The concept of using the measurements from two access nodes 300a, 300b to determine the orientation of the wireless device 400 is illustrated in FIG. 4. In FIG. 4 is shown that the first access node 300a and the second access node 300b both are oriented with respect to a first coordinate system defined by unit vectors x_{BS}, y_{BS}, and z_{BS}, whereas the wireless device 400 is oriented with respect to a second coordinate system defined by unit vectors x_{UE}, y_{UE}, and z_{UE}. With respect to the wireless device 400, the first access node 300a is located in the direction given by the vector \hat{r}_{UE1}, and the second access node 300b is located in the direction given by the vector \hat{r}_{UE2}. With respect to the first access node 300a, the wireless device 400 is located in the direction given by the vector \hat{r}_{BS1}, and with respect to the second access node 300b, the wireless device 400 is located in the direction given by the vector \hat{r}_{BS2}.

In some aspects, the orientation of the wireless device 400 is determined by alignment of vectors. In particular, in some embodiments, the control unit 200 is configured to perform optional step S106:

S106: The control unit 200 determines, from the first angular measurements, a first vector \hat{r}_{BS}. The first vector \hat{r}_{BS} is defined by a direction from the first access node 300a towards the wireless device 400 in the first coordinate system. The control unit 200 further determines, from the second angular measurements, a second vector \hat{r}_{UE}. The second vector \hat{r}_{UE} is defined by a direction from the wireless device 400 towards the first access node 300a in the second coordinate system.

The rotation of the second coordinate system might then correspond to that the second vector \hat{r}_{UE} in the thus rotated second coordinate system equals the first vector \hat{r}_{BS} in the first coordinate system, except for being in opposite direction.

Further in this respect, the orientation of the wireless device 400 might be determined in terms of rotation of unit vectors. In particular, in some embodiments, the first coordinate system is defined by a first set of unit vectors x_{BS}, y_{BS}, z_{BS}, and the second coordinate system is defined by a second set of unit vectors x_{UE}, y_{UE}, z_{UE}, and the orientation of the wireless device 400 is defined by vectors in the first coordinate system that correspond to the second set of unit vectors in the second coordinate system before rotation of the second coordinate system.

Consider, for example, that the coordinate system fixed to the wireless device 400 is given by unit vectors \hat{x}_{UE}, ŷ_{UE}, and \hat{z}_{UE}. This second coordinate system is rotated with respect to the first coordinate system given by the unit vectors \hat{x}, ŷ, and \hat{z}. Hereinafter all vectors used in the calculations are assumed to be row vectors. The first and second angular measurements yield a number of unit vectors \hat{r}_{UE1}, \hat{r}_{UE2}, . . . , \hat{r}_{UE,N} and \hat{R}_{BS,1}, \hat{r}_{BS,2}, . . . , \hat{r}_{BS,N}, where N is the number of angular measurements, from the wireless device 400 and the access nodes 300a, 300b, respectively. The second coordinate system fixed to the wireless device 400 can then be found by solving the following system of equations:

R_{UE}X_{UE}=R_{BS}X=R_{BS}I=R=_{BS} (2)

where R_{UE}=[\hat{r}_{UE,1}^{T}, \hat{r}_{UE,2}^{T}, . . . , \hat{r}_{UE,N}^{T}]^{T}, R_{BS}=[\hat{r}_{BS,1}^{T}, \hat{r}_{BS,2}^{T}, . . . , \hat{r}_{BS,N}^{T}]^{T}, X_{UE}=[\hat{x}_{UE}^{T} ŷ_{UE}^{T} \hat{z}_{UE}^{T}], and X=[\hat{x}^{T} ŷ^{T} \hat{z}^{T}].

In the system of equations (2), at least three equations might be needed. If there are only two measurements (i.e., first and second angular measurements between the wireless device 400 and the first access node 300a) it is possible to construct a third equation using \hat{r}_{UE,3}=\hat{r}_{UE,1}×\hat{r}_{UE,2} and \hat{r}_{BS,3}=\hat{r}_{BS,1}×\hat{r}_{BS,2}.

The solution to equation (2) is given by equation (3) if the number of measurements are two or three:

X_{UE}=R_{UE}⁻¹R_{BS} (3)

Alternatively, the solution to equation (2) is given by equation (4) if using ordinary least squares in the overdetermined case:

X_{UE}=(R_{UE}^{T}R_{UE})⁻¹R_{UE}^{T}R_{BS} (4)

Yet alternatively, the solution to equation (2) is given by equation (5) if using weighted least squares (5):

X_{UE}=(R_{UE}^{T}WR_{UE})⁻¹R_{UE}^{T}WR_{BS} (5)

where W is a weighting matrix. In this respect, the weighting matrix might be a diagonal matrix where the elements on the diagonal are the individual weights assigned to each corresponding observation, and where weights of observations of access nodes with higher signal strength (e.g. higher reference signal received power (RSRP) values) can be set higher than observations of access nodes with lower signal strength, as the observations of access nodes with higher signal strength might be more reliable than the observations of access nodes with lower signal strength.

If the wireless device 400 is equipped with at least one orientation indicating sensor, the orientation can be determined with angular measurements with respect to only one access node 300a. However, if angular measurements can be obtained with respect to at least two access nodes 300a, 300b, this corresponds to an overdetermined system of equations. By solving the overdetermined system of equations using a least squared error method, the orientation error can be reduced.

When calculating the orientation from the angular measurements as described above, it is in some aspects assumed that the wireless device 400 has not moved or rotated during the time when the angular measurements have been obtained. Hence, in some embodiments, all angular measurements are made without any relative movement being performed between the first access node 300a and the wireless device 400.

In some aspects, if the wireless device 400 is moving or rotating, it is required that the angular measurements are made at the same time. That is, in some embodiments, all angular measurements are made within a predetermined time interval.

In some aspects, several consecutive angular measurements are combined with time stamping of each measurement, so that the actual angle in question at a specific time can be estimated based on a combination (such as interpolation or similar) of at least two consecutive angular measurements. That is, in some embodiments, there are several of each of the angular measurements, and where each of the angular measurements is timestamped, and wherein interpolation is made between angular measurements of different timestamps. In this way, the estimated angles at a specified time instant can be used for orientation determination even if the angular measurements are not performed at the same time instant at both the wireless device 400 and the access node(s) 300a, 300b.

As noted above, some existing techniques for estimating the orientation of a device, such as a wireless device, work only outdoors. In some aspects, the herein disclosed determination of the orientation of the wireless device 400 is therefore combined with other orientation determining techniques in order to improve the performance, in terms of reliability and/or accuracy, of such other orientation determining techniques. That is, in some embodiments, the orientation of the wireless device 400 is determined in combination with at least one other means of orientation determining for the wireless device 400. Non-limiting examples of such other means of orientation determining are orientation determination based on GNSS, IMU, or AHRS.

One particular embodiment for orientation determination of a wireless device 400 with respect to a first coordinate system as performed by the control unit 200 based on at least some of the above disclosed embodiments will now be disclosed with reference to the flowchart of FIG. 5.

S201: Measurement of the signal phase and amplitude at the antennas. At both the wireless device 400 and the access node(s) 300a, 300b the phase and amplitude of received signals is measured in at least three antennas and in at least two different directions. The three antennas at each device are not located along a straight line. The collected phase measurements are the relative phase differences between the antennas within each antenna array. The collection of measurements is performed at each antenna array.

S202: Calculation of the AoA or AoD. The AoA or AoD is calculated using the phase differences and amplitude differences from step S201. The accuracy of the AoA or AoD estimation depends on the number of antennas in the different directions in the antenna array. The more antennas in a specific direction, the higher estimation accuracy can be achieved. In situations with no, or insignificant, multipath propagation it is sufficient to use the phase differences to determine the AoA or AoD. If multipath propagation is significant, additional steps to discriminate between the LoS component and possible NLoS components may have to be performed. The calculation of the AoA or AoD can be performed either by the wireless device 400 itself, the first access node 300a itself, at least partly by the wireless device 400 and at least partly by the first access node 300a, by a core network node operatively connected to the first access node 300a, or by the control unit 200.

S203: Collection of data. The data, in form of calculated AoA or AoD is collected at the control unit 200. The collection of data entails signaling of the data (AoA/AoD and/or possible phase measurements) from either the access node(s) 300a, 300b to the wireless device 400, or from the wireless device 400 to the access node(s) 300a, 300b, and/or from these entities to the core network node or to the control unit 200.

S204: Orientation calculation. The orientation of the coordinate system of the wireless device 400, and thus the orientation of the wireless device 400 itself, is determined by the control unit 200. This can be expressed as either the angles describing the rotation of the coordinate system of the wireless device 400 with respect to the global coordinate system (for example pitch, yaw and roll).

The determination of the orientation of the wireless device 400 can also be performed using the same theory as star tracking systems. The known directions to the stars in a global coordinate system is here replaced by the angular measurements at the access nodes 300a, 300b and the directions towards the stars in the local coordinate system (fixed to the wireless device 400 of which the orientation is to be determined) is replaced by the angular measurements at the wireless device 400. One example of the basic theory can be found in the appendix of R. B. Horsfall, “Stellar inertial navigation,” IRE Transactions on Aeronautical and Navigational Electronics, pp. 106-114, June 1958 and several algorithms that can be used to determine the orientation using a star sensor are described in Section 5.1 of S. Bae and B. E. Schutz, “Precision Attitude Determination (PAD),” Technical report, Center for Space Research, The University of Texas at Austin, October 2002.

The herein disclosed embodiments can be readily applied in any radio-based system utilizing angular measurements, e.g. in new radio (NR) based cellular systems, Long Term Evolution (LTE) based cellular systems, IEEE 802.11 based local area networks, Bluetooth based systems, or ultra-wide band (UWB) cellular systems.

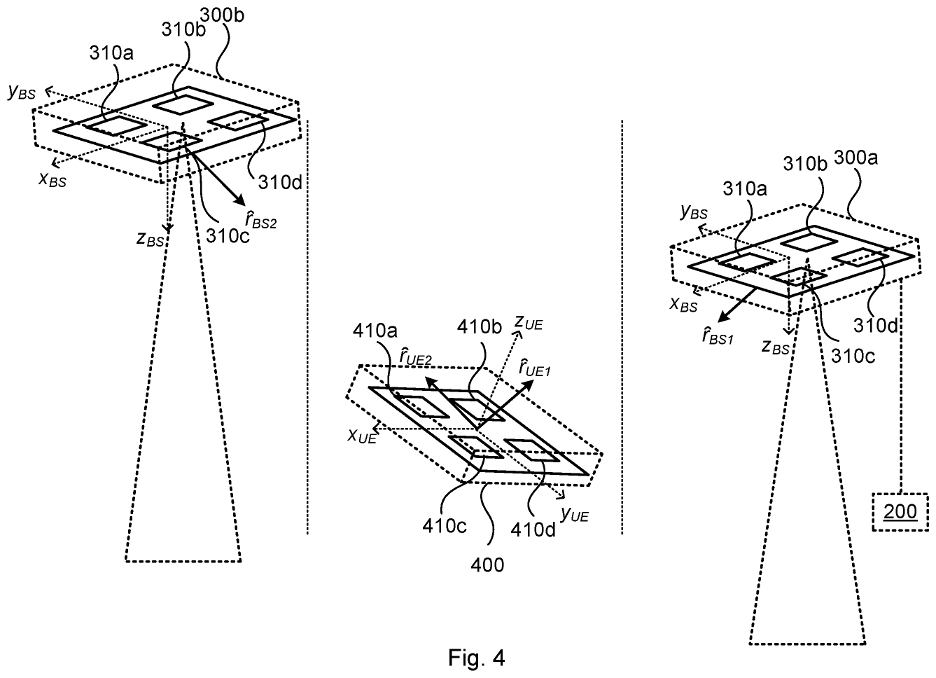

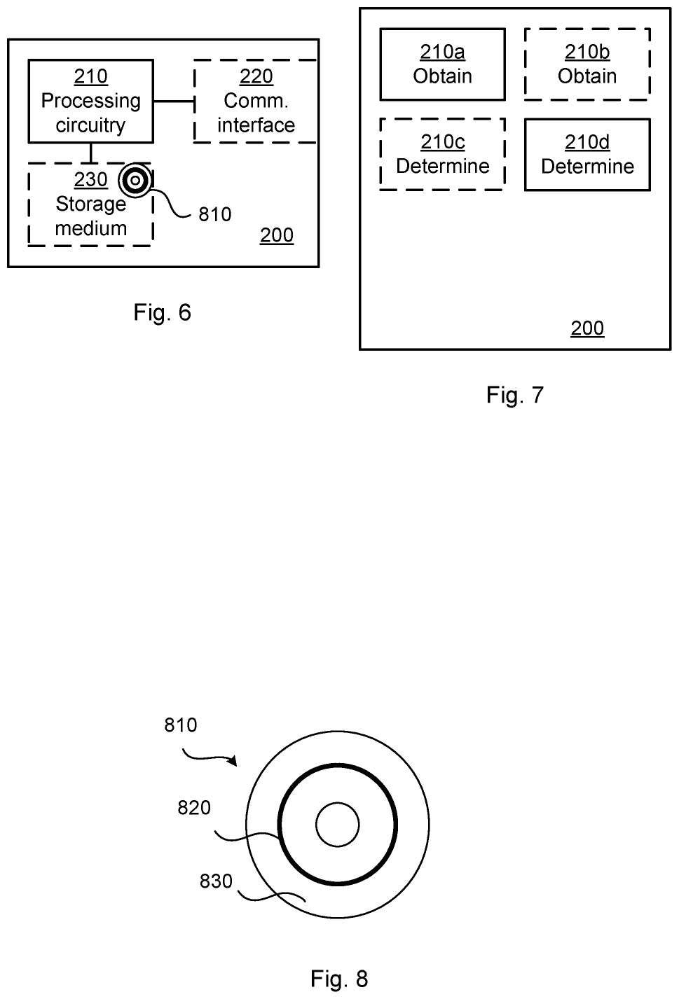

FIG. 6 schematically illustrates, in terms of a number of functional units, the components of a control unit 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 810 (as in FIG. 8), e.g. in the form of a storage medium 230. The processing circuitry 210 may further be provided as at least one application specific integrated circuit (ASIC), or field programmable gate array (FPGA).

Particularly, the processing circuitry 210 is configured to cause the control unit 200 to perform a set of operations, or steps, as disclosed above. For example, the storage medium 230 may store the set of operations, and the processing circuitry 210 may be configured to retrieve the set of operations from the storage medium 230 to cause the control unit 200 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The control unit 200 may further comprise a communications interface 220 at least configured for communications with other entities, functions nodes, and devices, such as the wireless device 400 and/or at least one access node 300a, 300b. As such the communications interface 220 may comprise one or more transmitters and receivers, comprising analogue and digital components. The processing circuitry 210 controls the general operation of the control unit 200 e.g. by sending data and control signals to the communications interface 220 and the storage medium 230, by receiving data and reports from the communications interface 220, and by retrieving data and instructions from the storage medium 230. Other components, as well as the related functionality, of the control unit 200 are omitted in order not to obscure the concepts presented herein.

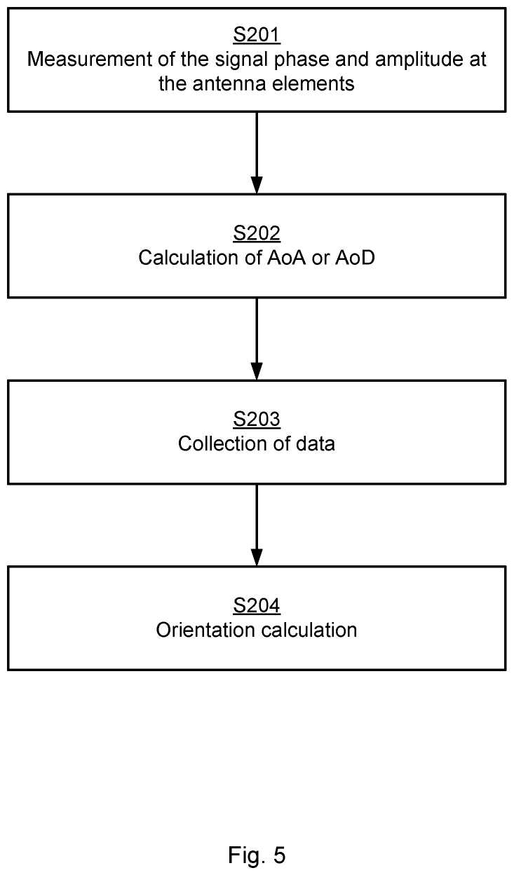

FIG. 7 schematically illustrates, in terms of a number of functional modules, the components of a control unit 200 according to an embodiment. The control unit 200 of FIG. 7 comprises a number of functional modules; an obtain module 210a configured to perform step S102, and a determine module 210d configured to perform step S108. The control unit 200 of FIG. 7 may further comprise a number of optional functional modules, such as any of an obtain module 210b configured to perform step S104, and a determine module 210c configured to perform step S106. In general terms, each functional module 210a:210d may in one embodiment be implemented only in hardware and in another embodiment with the help of software, i.e., the latter embodiment having computer program instructions stored on the storage medium 230 which when run on the processing circuitry makes the control unit 200 perform the corresponding steps mentioned above in conjunction with FIG. 7. It should also be mentioned that even though the modules correspond to parts of a computer program, they do not need to be separate modules therein, but the way in which they are implemented in software is dependent on the programming language used. Preferably, one or more or all functional modules 210a:210d may be implemented by the processing circuitry 210, possibly in cooperation with the communications interface 220 and/or the storage medium 230. The processing circuitry 210 may thus be configured to from the storage medium 230 fetch instructions as provided by a functional module 210a:210d and to execute these instructions, thereby performing any steps as disclosed herein.

The control unit 200 may be provided as a standalone device or as a part of at least one further device. For example, the control unit 200 might be part of the wireless device 400 or the first access node 300a or a core network node. The core network node is operatively connected to the first access node 300a. Alternatively, functionality of the control unit 200 may be distributed between at least two devices, or nodes. These at least two nodes, or devices, may either be part of the same network part (such as the access network or the core network) or may be spread between at least two such network parts. In general terms, instructions that are required to be performed in real time may be performed in a device, or node, operatively closer to the cell than instructions that are not required to be performed in real time.

Thus, a first portion of the instructions performed by the control unit 200 may be executed in a first device, and a second portion of the of the instructions performed by the control unit 200 may be executed in a second device; the herein disclosed embodiments are not limited to any particular number of devices on which the instructions performed by the control unit 200 may be executed. Hence, the methods according to the herein disclosed embodiments are suitable to be performed by a control unit 200 residing in a cloud computational environment. Therefore, although a single processing circuitry 210 is illustrated in FIG. 6 the processing circuitry 210 may be distributed among a plurality of devices, or nodes. The same applies to the functional modules 210a:210d of FIG. 7 and the computer program 820 of FIG. 8.

FIG. 8 shows one example of a computer program product 810 comprising computer readable storage medium 830. On this computer readable storage medium 830, a computer program 820 can be stored, which computer program 820 can cause the processing circuitry 210 and thereto operatively coupled entities and devices, such as the communications interface 220 and the storage medium 230, to execute methods according to embodiments described herein. The computer program 820 and/or computer program product 810 may thus provide means for performing any steps as herein disclosed.

In the example of FIG. 8, the computer program product 810 is illustrated as an optical disc, such as a CD (compact disc) or a DVD (digital versatile disc) or a Blu-Ray disc. The computer program product 810 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 820 is here schematically shown as a track on the depicted optical disk, the computer program 820 can be stored in any way which is suitable for the computer program product 810.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1-20. (canceled)

21. A method for orientation determination of a wireless device with respect to a first coordinate system, the method being performed by a control unit, the method comprising:
obtaining first angular measurements of the wireless device at a first access node and second angular measurements of the first access node at the wireless device, wherein the first access node is oriented in the first coordinate system, and wherein the wireless device is oriented in a second coordinate system; and
determining, by aligning the second angular measurements with the first angular measurements, an amount of rotation of the second coordinate system with respect to the first coordinate system, wherein the orientation of the wireless device with respect to the first coordinate system is defined by the amount of the rotation.

22. The method according to claim 21, wherein the orientation of the wireless device further is determined by supplementary orientation indicating information.

23. The method according to claim 21, wherein the method further comprises:
obtaining third angular measurements of the wireless device at a second access node and fourth angular measurements of the second access node at the wireless device, wherein the second access node is oriented in the first coordinate system, and wherein the orientation of the wireless device further is defined by an amount of rotation of the second coordinate system with respect to the first coordinate system needed for aligning the fourth angular measurements with the third angular measurements.

24. The method according to claim 22, wherein the orientation of the wireless device further is determined by supplementary orientation indicating information and wherein the third angular measurements and the fourth angular measurements define the supplementary orientation indicating information.

25. The method according to claim 21, wherein the wireless device is equipped with at least one orientation indicating sensor, and wherein the orientation of the wireless device further is determined using an orientation indicating signal as provided by the orientation indicating sensor.

26. The method according to claim 25, wherein:
the orientation of the wireless device further is determined by supplementary orientation indicating information; and
the orientation indicating signal defines the supplementary orientation indicating information.

27. The method according to claim 25, wherein the orientation indicating sensor is any of: an accelerometer, a gravity sensor, a magnetometer.

28. The method according to claim 21, wherein all angular measurements are made without any relative movement being performed between the first access node and the wireless device.

29. The method according to claim 21, wherein all angular measurements are made within a predetermined time interval.

30. The method according to claim 21, wherein there are several of each of the angular measurements, and where each of the angular measurements is timestamped, and wherein interpolation is made between angular measurements of different timestamps.

31. The method according to claim 21, wherein the orientation of the wireless device is determined in combination with at least one other means of orientation determining for the wireless device.

32. The method according to claim 21, wherein the angular measurements are determined by any of: the wireless device, the first access node, at least partly by the wireless device and at least partly by the first access node, by a core network node operatively connected to the first access node.

33. The method according to claim 21, wherein the control unit is part of the wireless device or the first access node or a core network node, wherein the core network node is operatively connected to the first access node.

34. The method according to claim 21, wherein the first coordinate system is a global coordinate system.

35. The method according to claim 21, wherein the first coordinate system is a coordinate system local to the first access node.

36. The method according to claim 21, wherein the angular measurements are any of: angle-of-arrival measurements, angle-of-departure measurements.

37. The method according to claim 36, wherein, when the first angular measurements are angle-of-arrival measurements, the first angular measurements represent the angle-of-arrival of a signal received by the first access node from the wireless device.

38. A control unit for orientation determination of a wireless device with respect to a first coordinate system, the control unit comprising processing circuitry, the processing circuitry being configured to cause the control unit to:
obtain first angular measurements of the wireless device at a first access node and second angular measurements of the first access node at the wireless device, wherein the first access node is oriented in the first coordinate system, and wherein the wireless device is oriented in a second coordinate system; and
determine, by aligning the second angular measurements with the first angular measurements, an amount of rotation of the second coordinate system with respect to the first coordinate system, wherein the orientation of the wireless device with respect to the first coordinate system is defined by the amount of the rotation.

39. A non-transitory, computer-readable medium comprising executable program code that, when executed by processing circuitry of a control unit, causes the control unit to:
obtain first angular measurements of the wireless device at a first access node and second angular measurements of the first access node at the wireless device, wherein the first access node is oriented in the first coordinate system, and wherein the wireless device is oriented in a second coordinate system; and
determine, by aligning the second angular measurements with the first angular measurements, an amount of rotation of the second coordinate system with respect to the first coordinate system, wherein the orientation of the wireless device with respect to the first coordinate system is defined by the amount of the rotation.
